(19) United States
(12) Patent Application Publication
(10) Pub. No.: US 2009/0160738 A1
(43) Pub. Date: Jun. 25, 2009

(54) OPTICAL ARTICLE HAVING PROTECTIVE LAYER

(75) Inventors: Mark J. Pellerite, Woodbury, MN (US); Hang K. Loi, Woodbury, MN (US); James E. Lockridge, St. Paul, MN (US); Gregory F. King, Minneapolis, MN (US); David A. Kowitz, St. Paul, MN (US); Eileen M. Haus, St. Paul, MN (US); Jeffrey A. Peterson, Lake Elmo, MN (US); Richard J. Pokorny, Maplewood, MN (US); Michael L. Steiner, New Richmond, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/959,819

(22) Filed: Dec. 19, 2007

(51) Int. Cl. G09G 3/00; B05D 5/06; B32B 7/02; B32B 3/00

(52) U.S. Cl. 345/32; 428/212; 428/141; 427/162; 427/163.1

(57) ABSTRACT

Disclosed herein is an optical article including a multilayer optical film of alternating layers of first and second optical layers, wherein the first and second optical layers have refractive indices along at least one axis that differ by at least 0.04; and a protective layer disposed on an outer surface of the multilayer optical film, the protective layer having a thickness of less than about 0.5 um and including crosslinked hydroxylated polymer. The optical article may further include a microstructured layer disposed on an outer surface of the multilayer optical film opposite the protective layer. Also disclosed herein are a method of making the optical article and a display device including the optical article.

### FIELD OF THE INVENTION

This disclosure relates to optical articles, particularly multilayer optical films comprising a plurality of alternating optical layers.

### BACKGROUND

Many liquid crystal displays incorporate one or more types of brightness enhancement (BEF) films to increase brightness and reduce power consumption. One type of BEF film is a prismatic film comprising a polymeric substrate bearing a layer of prism structures that act to channel light into the field of view that would ordinarily be scattered out to higher viewing angles. The prisms are applied by coating a UV-curable acrylic resin on the polymer substrate followed by curing against a microstructured roll. Another type of BEF film is a multilayer optical film, typically a reflective polarizer, comprising alternating layers of two different polymeric materials that have been extruded together and subsequently stretched. Liquid crystal displays may incorporate both types of BEF films in a configuration in which the prism structures of a prismatic film are adjacent a multilayer optical film. The prism pattern can “imprint” into the multilayer film. Prismatic films in which the polymeric substrate is a multilayer optical film are also known. When this type of BEF film is wound up in roll form, the prism pattern can undesirably imprint into the multilayer optical film. In both cases, imprinted prism structures can cause haze and disrupt optical performance.

### SUMMARY

In one aspect, disclosed herein is an optical article comprising: a multilayer optical film comprising alternating layers of first and second optical layers, wherein the first and second optical layers have refractive indices along at least one axis that differ by at least 0.04; and a protective layer disposed on an outer surface of the multilayer optical film, the protective layer having a thickness of less than about 0.5 um and comprising crosslinked hydroxylated polymer. The multilayer optical film may comprise a reflective film, a polarizer film, a reflective polarizer film, a diffuse blend reflective polarizer film, a diffuser film, a brightness enhancing film, a turning film, a mirror film, or a combination thereof. The optical article may further comprise a microstructured layer disposed on an outer surface of the multilayer optical film opposite the protective layer, wherein the microstructured layer comprises a structured surface having a plurality of microstructures, and the structured surface comprises an outer surface of the optical article.

In another aspect, also disclosed herein is a method of making the optical article, comprising: providing a multilayer optical film comprising alternating layers of first and second optical layers, wherein the first and second optical layers have refractive indices along at least one axis that differ by at least 0.04; coating a protective layer composition on the multilayer optical film, the protective layer composition comprising hydroxylated polymer and a crosslinking agent; and drying the protective layer composition thereby forming a protective layer having a thickness of less than about 0.5 um.

In another aspect, also disclosed herein is a display device comprising: a display panel; a light source; and an optical article disposed between the display panel and the light source, the optical article comprising: a multilayer optical film comprising alternating layers of first and second optical layers, wherein the first and second optical layers have refractive indices along at least one axis that differ by at least 0.04; and a protective layer disposed on an outer surface of the multilayer optical film, the protective layer having a thickness of less than about 0.5 um and comprising crosslinked hydroxylated polymer.

These and other aspects of the invention are described in the detailed description below. In no event should the above summary be construed as a limitation on the claimed subject matter which is defined solely by the claims as set forth herein.

### BRIEF DESCRIPTION OF THE DRAWINGS

The invention may be more completely understood in consideration of the following detailed description in connection with the following figures:

FIGS. 1 and 2 show schematic cross sectional views of exemplary optical articles.

### DETAILED DESCRIPTION

Disclosed herein is a protective layer which may be formed on a multilayer optical film. The protective layer may provide numerous advantages. For one, the protective layer can be used to prevent imprinting caused by prism structures of prismatic films when in contact with the multilayer optical film.

The protective layer may also be advantageous because it has a thickness of less than about 0.5 um. Most layers capable of preventing imprinting are 0.8 um or greater.

The protective layer may also be advantageous because it can be applied before the multilayer polymer film is stretched to form the multilayer optical film, and also, it can be applied during the manufacture of the multilayer optical film. These features help to streamline the manufacturing process by reducing the need to handle the film which, in turn, results in fewer film defects and increases yield.

A common method of creating a protective layer is through coating a stretched film with a solvent-based acrylate followed by drying and UV curing. This process tends to impart tensions on one side of the multilayer film which results in curl of the final product. The method enabled by this invention of applying the protective coating before stretching allows the tensions to relax which results in a dramatic reduction in curl.

The protective layer may also be advantageous because it is formed from an aqueous-based composition as opposed to a solvent-based composition. It may also improve the scratch resistance of the film and eliminate the need for protective premask films.

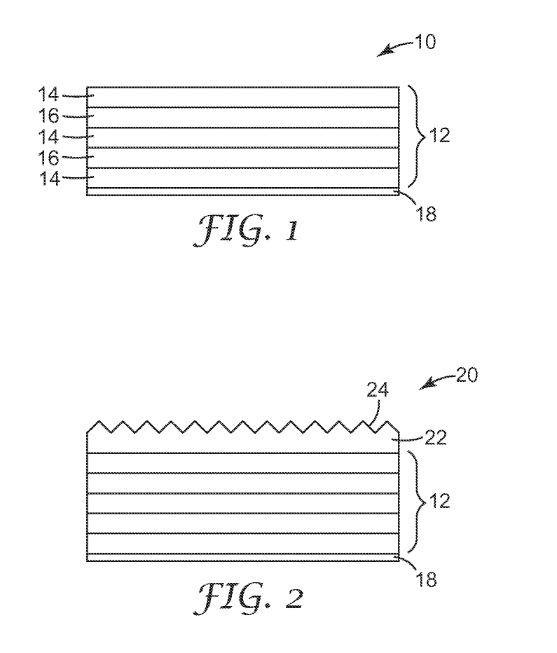

FIG. 1 shows a cross sectional view of an exemplary optical article disclosed herein. Optical article 10 comprises multilayer optical film 12 comprising a plurality of alternating layers of first and second optical layers, 14 and 16, respectively. Protective layer 18 is formed on an outer surface of the multilayer optical film. The protective layer can have any suitable thickness provided it can impart the desired optical properties to the article. Generally, a thickness of less than about 0.5 um is useful. In some embodiments, the protective layer has a thickness of less than about 0.3 um, less than about 0.1 um, or less than about 0.70 um. The protective layer is desirably thin enough so that it does not affect the optical properties of the optical article. The protective layer should also be thick enough to prevent imprinting of microstructures as described below.

The protective layer comprises crosslinked hydroxylated polymer selected from the group consisting of poly(vinyl alcohol) and a vinyl alcohol copolymer. In general, the poly(vinyl alcohol) has properties such as clarity and solubility in water.

In some embodiments, poly(vinyl alcohol) having a degree of hydrolysis of from 88 to 98% may be used. Below 88% hydrolysis, imprint resistance may be reduced, while above 98% hydrolysis the solution viscosities may be so high as to reduce coatability of the solutions. For example, the poly(vinyl alcohol) may have a degree of hydrolysis of from 88 to 95%. In some embodiments, poly(vinyl alcohol) having a 4% solution viscosity of from 4 to 56 cP may be used. Solutions with viscosities in this range are suitable for application to the film by commonly-used industrial coating techniques. For example, the poly(vinyl alcohol) may have a 4% solution viscosity of from 18 to 40 cP.

In some embodiments, a vinyl alcohol copolymer may be used in combination with the crosslinking agent discussed below. Such materials are exemplified by copolymers of ethylene and vinyl alcohol such as EXCEVAL from Kuraray Corp, copolymers of vinyl alcohol with vinylsilanes such as vinyltrimethoxysilane and vinyl triethoxysilane, and copolymers of vinyl alcohol with vinylamine.

In general, the crosslinking agent may be selected such that it allows for clear coatings with low haze (generally under 5%) and gives good adhesion to the underlying substrate as measured by a tape pull test, in addition to water resistance. Factors that may determine the particular choice of crosslinker include pot life, solution stability, and tenterability (do not want a brittle film). For example, the crosslinking agent may comprise a dialdehyde such as glutaraldehyde or glyoxal, an epoxy such as bisphenol A diepoxide, an isocyanate such as XR-5305 available from Stahl Chemical, a zirconium carboxylate complex such as Bacote 20 available from MelChemicals, an epichlorohydrin/amine adduct such as Polycup 172 available from Hercules, a melamine/formaldehyde resin such as Cymel 327 available from Cytec Industries, a poly(carbodiimide) such as XR-5577 available from Stahl Chemical, or a chemically compatible combination thereof. Other examples of crosslinking agents include boric acid and borates, germaniac acids and germanates, titanium salts and esters, chromates and vanadates, cupric salts and other Group IB salts, and monoaldehydes such as formaldehyde.

In general, the amount of crosslinking agent used depends on the desired performance of the final coating. If too much crosslinking agent is used, then imprint resistance is diminished. If too little is used, then adhesion of the coating to the substrate is poor. For example, ratio of poly(vinyl alcohol) to crosslinking agent can be from about 20:1 to about 5:1, from about 15:1 to about 7:1, or from about 12:1 to about 9:1.

Other components that may be used in the protective layer composition include biocides for increasing pot life. Plasticizers may also be used for improving tenterability as the Tg and the melting temperatures of the coated film are reduced. Examples of plasticizers include glycerin, diethylene glycol, polyethylene glycol, and polypropylene glycol.

The protective layer may contain other types of additives. Preferably, such materials should be compatible with the primary components of the coating and coating formulation, and should not adversely affect performance attributes of the optical article. These include coating aids such as surfactants, and coalescing solvents including glycols, polyglycols, and substituted derivatives thereof such as Dowanol solvents available from Dow Chemical; defoaming agents; particulates used as, for instance, slip agents; antioxidants; catalysts such as acids, bases, ammonium halide and sulfonate salts, sulfonium and iodonium salts, and metal compounds such as dibutyltin esters; and pH control agents such as buffers or trialkylamines. Use of relatively volatile trialkylamines such as triethylamine and dimethylethanolamine as pH stabilizers is particularly preferred for coating formulations comprising melamine-formaldehyde crosslinking agents, since pH drift into the acid range can cause undesirable shortened pot life and premature gelation.

Also disclosed herein is a method of making the optical article. The method comprises coating the protective layer composition described above onto a multilayer optical film, thereby forming a coated multilayer optical film. Typically, the components in the protective layer composition are dissolved, dispersed, or suspended in a suitable solvent for the coating step. The particular solvent used depends upon the particular components, the desired concentrations of the components, the desired thickness and nature of the layer, the coating method employed, etc. Suitable solvents include water. Generally, compositions used to form the protective layer comprise up to about 15 wt. % solids relative to the weight of the total composition.

The protective layer composition may be coated using a variety of coating techniques such as dip, roll, die, knife, air knife, slot, slide, wire wound rod, and curtain coating. A comprehensive discussion of coating techniques can be found in Cohen, E. and Gutoff, E. Modern Coating and Drying Technology; VCH Publishers: New York, 1992; p. 122; and in Tricot, Y-M. Surfactants: Static and Dynamic Surface Tension. In Liquid Film Coating; Kistler, S. F. and Schweizer, P. M., Eds.; Chapman & Hall: London, 1997; p. 99.

The protective layer composition can be cured using heat or UV radiation or any other suitable curing technique. One preferred method of curing is thermal activation and crosslinking of the protective layer composition using the latent heat of a film tentering process.

The multilayer optical film may comprise any of a variety of materials including polyesters such as polyethylene terephthalate, polyethylene naphthalate, copolyesters or polyester blends based on naphthalene dicarboxylic acids; polycarbonates; polystyrenes; styrene-acrylonitriles; cellulose acetates; polyether sulfones; poly(meth)acrylates such as polymethylmethacrylate; polyurethanes; polyvinyl chloride; polycyclo-olefins; polyimides; glass; paper; or combinations or blends thereof. Particular examples include polyethylene terephthalate, polymethyl methacrylate, polyvinyl chloride, and cellulose triacetate. Preferable examples include polyethylene terephthalate, polyethylene naphthalate, cellulose triacetate, polypropylene, polyester, polycarbonate, polymethylmethacrylate, polyimide, polyamide, or a blend thereof. Preferably, the multilayer optical film is sufficiently resistant to temperature and aging such that performance of the optical article is not compromised over time. The thickness of the multilayer optical film is typically less than about 2.5 mm. The multilayer optical film may also be an orientable film such as a cast web substrate that is coated before orientation in a tentering operation.

The multilayer optical film may comprise a light transmissive substrate such that the optical article is suitable for use in optical applications. Useful light transmissive multilayer optical films are optically clear and designed to control the flow of light and may have a transmission of greater than about 90%. The multilayer optical film may exhibit minimal haze, having a haze value of less than about 5%, for example, less than 2%, or less than 1%. Properties to consider when selecting a suitable multilayer optical film include mechanical properties such as flexibility, dimensional stability, self-supportability, and impact resistance. For example, the multilayer optical film may need to be structurally strong enough so that the optical article can be assembled as part of a display device.

The multilayer optical film may comprise an optical film that is used in a wide variety of applications such as graphic arts and optical applications. A useful optical film may be described as a reflective film, a polarizer film, a reflective polarizer film, a diffuse blend reflective polarizer film, a diffuser film, a brightness enhancing film, a turning film, a mirror film, or a combination thereof. The optical film may comprise a multilayer optical film having ten or less layers, hundreds, or even thousands of layers, the layers being composed of some combination of all birefringent optical layers, some birefringent optical layers, or all isotropic optical layers. In one embodiment, the multilayer optical film has alternating layers of first and second optical layers, wherein the first and second optical layers have refractive indices along at least one axis that differ by at least 0.04. Multilayer optical films having refractive index mismatches are described in the references cited below.

Useful substrates include commercially available optical films marketed as Vikuiti™ Dual Brightness Enhanced Film (DBEF), Vikuiti™ Diffuse Reflective Polarizer Film (DRPF), Vikuiti™ Enhanced Specular Reflector (ESR), and Vikuiti™ Advanced Polarizing Film (APF), all available from 3M Company. Useful optical films are also described in U.S. Pat. Nos. 5,825,543; 5,828,488 (Ouderkirk et al.); 5,867,316; 5,882,774; 6,179,948 B1 (Merrill et al.); 6,352,761 B1; 6,368,699 B1; 6,927,900 B2; 6,827,886 (Neavin et al.); 6,972,813 B1 (Toyooka); 6,991,695; 2006/0084780 A1 (Hebrink et al.); 2006/0216524 A1; 2006/0226561 A1 (Merrill et al.); 2007/0047080 A1 (Stover et al.); WO 95/17303; WO 95/17691; WO 95/17692; WO 95/17699; WO 96/19347; WO 97/01440; WO 99/36248; and WO 99/36262. These optical films are merely illustrative and are not meant to be an exhaustive list of multilayer optical films that can be used.

After the protective layer is formed on a suitable multilayer optical film, the coated multilayer optical film can then be tentered or stretched in one or two dimensions in order to orient the multilayer optical film. The process of orienting film, particularly polyester films, is described in Volume 12 of The Encyclopedia of Polymer Science and Engineering, 2nd edition, pages 193 to 216. A typical process for fabricating biaxially oriented polyester films comprises four main steps: (1) melt extrusion of the polyester resin and quenching it to form a web, (2) drawing the web in the longitudinal or machine direction, (3) subsequently or simultaneously drawing the web in the transverse direction to create a film, and (4) heat setting the film. If biaxial orientation is desired, the protective layer composition may be coated on the multilayer optical film after it has been drawn in the machine direction but before it has been subsequently drawn in the transverse direction. Further discussion on the orientation of polymeric films can be found in WO 2006/130142 (Karg et al.) and the previously cited references on optical films.

The optical article may further comprise a microstructured layer disposed on an outer surface of the multilayer optical film opposite the protective layer, wherein the microstructured layer comprises a structured surface having a plurality of microstructures, and the structured surface comprises an outer surface of the optical article. FIG. 2 shows a schematic cross-section of such an exemplary optical article 20 having microstructured layer 22 disposed on multilayer optical film 12. The microstructured layer has microstructured surface 24 which comprises an array of prisms for directing light. A comprehensive discussion of the behavior of light in a BEF film may be found, for example, in US 2007/0115407 A1.

In general, the microstructured surface may comprise any type of shape, pattern, etc. that may be useful in optical applications. The microstructured surface may also comprise, for example, a series of shapes including ridges, posts, pyramids, hemispheres and cones, and/or they may be protrusions or depressions having flat, pointed, truncated, or rounded parts, any of which may have angled or perpendicular sides relative to the plane of the surface. Any lenticular microstructure may be useful, for example, the microstructured surface may comprise cube corner elements, each having three mutually substantially perpendicular optical faces that typically intersect at a single reference point, or apex. The microstructured surface may have a regularly repeating pattern, be random, or a combination thereof. In general, the microstructured surface comprises one or more features, each feature having at least two lateral dimensions (i.e. dimensions in the plane of the film) less than 2 mm.

The microstructured layer may be prepared using a polymerizable composition, a master having a negative microstructured molding surface, and a preformed second polymeric layer sometimes referred to as a base layer. The polymerizable composition is deposited between the master and the second polymeric layer, either one of which is flexible, and a bead of the composition is moved so that the composition fills the microstructures of the master. The polymerizable composition is polymerized to form the layer and is then separated from the master. The master can be metallic, such as nickel, nickel-plated copper or brass, or can be a thermoplastic material that is stable under the polymerizing conditions and that preferably has a surface energy that permits clean removal of the polymerized layer from the master. The first polymeric layer with the microstructured surface may have a thickness of from about 10 to about 200 um.

The polymerizable composition may comprise monomers including mono-, di-, or higher functional monomers, and/or oligomers, and preferably, those having a high index of refraction, for example, greater than about 1.4 or greater than about 1.5. The monomers and/or oligomers may be polymerizable using UV radiation. Suitable materials include (meth)acrylates, halogenated derivatives, telechelic derivatives, and the like, for example, those described in U.S. Pat. Nos. 4,568,445; 4,721,377; 4,812,032; 5,424,339; and 6,355,754; all incorporated herein by reference. A preferable polymerizable composition is described in U.S. 2005/147838 A1. This polymerizable composition comprises a first monomer comprising a major portion of 2-propenoic acid, (1-methylethylidene)bis[(2,6-dibromo-4,1-phenylene)oxy(2-hydroxy-3,1-propanediyl)]ester; pentaerythritol tri(meth)acrylate; and phenoxyethyl(meth)acrylate.

The microstructured layer may be prepared using a polymerizable composition, a master having a negative microstructured molding surface, and the optical article. The polymerizable composition can be deposited between the master and the optical layer of the optical article, and a bead of the composition moved so that the composition fills the microstructures of the master. The polymerizable composition is polymerized to form the layer and is then separated from the master. The master can be metallic, such as nickel, nickel-plated copper or brass, or can be a thermoplastic material that is stable under the polymerizing conditions and that preferably has a surface energy that permits clean removal of the polymerized layer from the master. The master is further described in U.S. Pat. No. 4,542,449; U.S. Pat. No. 5,771,328; and U.S. Pat. No. 6,354,709. Alternatively, a pre-formed microstructured layer may be prepared and laminated to the optical article such that the optical layer is disposed between the microstructured layer and the substrate.

The article may be used in a graphic arts application, for example, in backlit signs, billboards, and the like. The article may also be used in a display device comprising, at the very least, one or more light sources and a display panel. The display panel may be of any type capable of producing images, graphics, text, etc., and may be mono- or polychromatic, or transmissive or reflective. Examples include a liquid crystal display panel, a plasma display panel, or a touch screen. The light sources may comprise fluorescent lamps, phosphorescent lights, light emitting diodes, or combinations thereof. Examples of display devices include televisions, monitors, laptop computers, and handheld devices such as cell phones, PDA's, calculators, and the like.

The invention may be more completely understood in consideration of the following examples.

### EXAMPLES

### Materials

Commercially available materials are described in Table 1 and were used as received.

TABLE 1

| Abreviation | Product Literature |
|---|---|
| CV540 | CELVOL 540 from Celanese Corp. |
| | molecular weight: mixture |
| | degree of hydrolysis: 87-89 mol % |
| | 4% solution viscosity: 45-55 cP |
| CV513 | CELVOL 513 from Celanese Corp. |
| | molecular weight: mixture |
| | degree of hydrolysis: 86-89 mol % |
| | 4% solution viscosity: 13-15 cP |
| MW 8-88 | MOWIOL 8-88 from Kuraray America Inc. |
| | degree of hydrolysis: 86.7-88.7 mol % |
| | 4% solution viscosity: 7-9 cP |
| MW 18-88 | MOWIOL 18-88 from Kuraray America Inc. |
| | degree of hydrolysis: 86.7-88.7 mol % |
| | 4% solution viscosity: 16.5-19.5 cP |
| MW 40-88 | MOWIOL 40-88 from Kuraray America Inc. |
| | degree of hydrolysis: 86.7-88.7 mol % |
| | 4% solution viscosity: 38.0-42.0 cP |
| MW 56-98 | MOWIOL 56-98 from Kuraray America Inc. |
| | degree of hydrolysis: 98-98.8 mol % |
| | 4% solution viscosity: 52.0-60.0 cP |
| PC172 | POLYCUP 172 from Hercules Inc. |
| | water soluble polyamide-epichlorohydrin |
| | crosslinking agent |
| C4045 | CYCAT 4045 from Cytec Industries |
| | aqueous solution of p-toluene sulfonic acid salt of |
| | diisopropanolamine |
| TOMADOL 25-9 | Tomah Products |
| | alcohol ethoxylate nonionic surfactant |
| RHOPLEX 3208 | from Rohm and Haas Co. |
| | aqueous acrylic dispersion of 34-35 wt. % of an |
| | acrylic binder and 8-9 wt % of a |
| | formaldehyde-melamine crosslinking resin |
| CYMEL 327 | from Cytec Industries |
| | melamine-formaldehyde crosslinking resin |

A polyester multilayer optical film was prepared using methods and materials described in US 2001/0013668 (Neavin et al.).

A UV-curable composition was used to make an outer layer having prismatic structures. This composition is described in US 2006/0004166 (Olson et al.) and was prepared by combining a first monomer comprising a major portion of 2-propenoic acid, (1-methylethylidene)bis[(2,6-dibromo-4,1-phenylene)oxy(2-hydroxy-3,1-propanediyl)]ester; pentaerythritol triacrylate; and phenoxyethyl acrylate. The resin also contained 0.35 wt % DAROCUR 1173 and 0.1 wt % DAROCUR TPO (diphenyl (2,4,6-trimethylbenzoyl)phosphine) both from Ciba Specialty Chemicals Corp., as photoinitiators.

### Test Methods

Coating samples were rated for anti-imprint performance using the following procedure. A construction was made by pressing a 3.81 cm×4.445 cm (1.5 in×1.75 in) sample of coated multilayer optical film against a sample of standard BEF prismatic film (from 3M™ Company) under a 50 g weight in an oven at 85° C. for 24 hr. The resulting coated multilayer optical film was then rated on a 0 to 9 scale, where 0 represents no visible imprinting.

Haze was measured using a Byk-Gardner HazeGard Plus meter. Adhesion of the crosslinked poly(vinyl alcohol layer) to the multilayer optical film was determined by staining the coating with a few drops of an aqueous solution of 1 g iodine and 15.82 g potassium iodide in 328 g deionized water, allowing it to dry, and running a tape pull test after lamination with a piece of 3M™ 610 adhesive tape available from 3M™ Company. Tests were run on the edge and center of the coated area. Coatings were rated “Pass” or “Fail” depending on whether any of the coating was removed with the tape. Visualization of the removed protective coating can be enhanced by treating the sample with a few drops of an aqueous solution of 1 g iodine and 15.82 g potassium iodide in 328 g deionized water. Abrasion susceptibility of the PVA coatings was measured using 5 cycles on a Taber abrader equipped with a CS-11 wheel, and results are reported as ΔHaze=Haze (after abrasion)−Haze (initial).

### Examples 1-15

PVA-based coating formulations shown in Table 2 were prepared in deionized water, and all formulations included 0.1 wt % TOMADOL 25-9 to ensure uniform wetting of the substrate. The formulations were coated inline at 10.2 m/min (33.6 ft/min) on a freshly extruded multilayer optical film substrate using a #6 wire-wound rod. Coatings were applied just prior to the film entering a drying oven set at 54° C. The other side of the web was continuously primed with a coating of 6 wt. % RHOPLEX dispersion in deionized water also containing 1.5 wt % CYMEL 327 crosslinker, 0.25 wt % C4045 catalyst, and 0.1 wt % TOMADOL 25-9, applied by air knife (applicator roll speed 40 ft/min, backup roll gap 50 mil, air pressure 2 psig). Immediately after coating, the film passed into a tenter that was divided into three zones—preheat, stretch, and heat set. Temperatures in deg C and dwell times in sec, respectively, for the three zones were as follows: Preheat, 122, 29; Stretch, 113, 57; Heat Set, 190, 25. Tranverse draw ratio in the stretch zone was 7.96:1, yielding a final substrate thickness of 3.66 mil.

Samples of each coating after tentering and winding were evaluated for haze and clarity, determination of coating adhesion, and abrasion using the methods described above with results shown in Table 3. A microstructured layer was then applied to the RHOPLEX-primed side with the UV-curable composition, which were prepared into brightness enhancing films as described in Olson et al. A master tool having 90° apex angles as defined by the slope of the sides of the prisms was used. The mean distance between adjacent apices was about 24 um. Processing conditions included line speed 60 ft/min; resin temperature 71° C.; tool temperature 60° C.; lamps, two D bulbs operating at 100% power on the tool, with one post-cure D bulb at 85% power; oven temperature 68° C. The resulting laminates were used to measure the anti-imprint performance of the PVA coating as described above. Results from these experiments are shown in Table 3 below.

### Comparative Example 1

Comparative Example 1 consisted of the multilayer optical film having a hardcoat of about 0.8 um. The hardcoat was obtained by coating a UV-curable, isopropanol-based formulation of acrylated silica particles, N,N-dimethyl acrylamide, and pentaerythritol triacrylate monomers. Preparation of the coating formulation, including coating and curing conditions, are described in Example 3 of U.S. Pat. No. 6,299,799 B1 (Craig et al.). Haze, anti-imprint, and abrasion testing were carried out as described above.

### Comparative Example 2

Comparative Example 1 consisted of the multilayer optical film. Haze, anti-imprint, and abrasion testing were carried out as described above.

TABLE 2

| | PVA Target | | | |
|---|---|---|---|---|
| | Thickness | PVA | PC172 | C4045 |
| Example | (nm) | (wt. %) | (wt. %) | (wt. %) |
| 1 | 91 | 6% CV540 | 0.6 | 0 |
| 2 | 82 | 6% CV540 | 0 | 0 |
| 3 | 91 | 6% CV540 | 0.6 | 0.06 |
| 4 | 91 | 6% CV513 | 0.6 | 0 |
| 5 | 91 | 6% MW8-88 | 0.6 | 0 |
| 6 | 91 | 6% MW18-88 | 0.6 | 0 |
| 7 | 91 | 6% MW40-88 | 0.6 | 0 |
| 8 | 91 | 6% MW56-98 | 0.6 | 0 |
| 9 | 91 | 4.5% MW8-88 + 1.5% | 0.6 | 0 |
| | | MW40-88 | | |
| 10 | 82 | 6% MW18-88 | 0 | 0 |
| 11 | 91 | 6% MW40-88 | 0.06 | 0.06 |
| 12 | 60 | 4% MW40-88 | 0.06 | 0 |
| 13 | 30 | 2% MW40-88 | 0.06 | 0 |
| 14 | 82 | 6% 40-88 | 0 | 0 |
| 15 | 82 | 4.5% MW8-88 + 1.5% | 0 | 0 |
| | | MW40-88 | | |

TABLE 3

| | PVA Adhesion | | Haze | Anti-imprint | |
|---|---|---|---|---|---|
| Example | (Edge/Center) | | (%) | Rating | Abrasion |
| 1 | P | P | 3.2 | 2 | 16.1 |
| 2 | F | P | 2.7 | 2 | 7.0 |
| 3 | P | P | 2.6 | 2 | 18.4 |
| 4 | P | P | 2.3 | 2 | 11.5 |
| 5 | P | P | 2.3 | 3 | 11.5 |
| 6 | P | P | 2.2 | 3 | 10.4 |
| 7 | P | P | 2.6 | 2 | 10.0 |
| 8 | P | P | 2.2 | 2 | 10.1 |
| 9 | P | P | 2.4 | 3 | 8.5 |
| 10 | F | P | 2.0 | 2 | 9.1 |
| 11 | P | P | 1.5 | 2 | 10.1 |
| 12 | P | P | 3.1 | 2 | 12.3 |
| 13 | P | P | 3.1 | 3 | 15.8 |
| 14 | F | F | 2.2 | 2 | 8.4 |
| 15 | F | F | 1.4 | 2 | 7.1 |
| Comparative 1 | — | — | 2.3 | 2 | 2.4 |
| Comparative 2 | — | — | 0.5 | 6-7 | 20 |

What is claimed is:

1. An optical article comprising:
a multilayer optical film comprising alternating layers of first and second optical layers, wherein the first and second optical layers have refractive indices along at least one axis that differ by at least 0.04; and
a protective layer disposed on an outer surface of the multilayer optical film, the protective layer having a thickness of less than about 0.5 um and comprising a crosslinked hydroxylated polymer, the crosslinked hydroxylated polymer comprising poly(vinyl alcohol) or a vinyl alcohol copolymer.

2. The optical article of claim 1, the protective layer having a thickness of less than about 0.3 um.

3. The optical article of claim 1, the protective layer having a thickness of less than about 0.1 um.

4. The optical article of claim 1, wherein the crosslinked hydroxylated polymer is derived from poly(vinyl alcohol) having a degree of hydrolysis of from 88 to 98%.

5. The optical article of claim 1, wherein the crosslinked hydroxylated polymer is derived from poly(vinyl alcohol) having a degree of hydrolysis of from 88 to 95%.

6. The optical article of claim 1, wherein the crosslinked hydroxylated polymer is derived from poly(vinyl alcohol) having a 4% solution viscosity of from 4 to 56 cP.

7. The optical article of claim 1, wherein the crosslinked hydroxylated polymer is derived from poly(vinyl alcohol) having a 4% solution viscosity of from 18 to 40 cP.

8. The optical article of claim 1, wherein the crosslinked hydroxylated polymer further comprises a crosslinking agent, the crosslinking agent may comprise glutaraldehyde, an epoxy, an isocyanate, a zirconium carboxylate complex, an epichlorohydrin/amine adduct, a melamine/formaldehyde resin, a poly(carbodiimide), or a combination thereof.

9. The optical article of claim 1, wherein the crosslinked hydroxylated polymer is derived from poly(vinyl alcohol) and a crosslinking agent in a ratio of from about 20:1 to about 5:1.

10. The optical article of claim 1, wherein the crosslinked hydroxylated polymer is derived from poly(vinyl alcohol) and a crosslinking agent in a ratio of from about 15:1 to about 7:1.

11. The optical article of claim 1, wherein the crosslinked hydroxylated polymer is derived from poly(vinyl alcohol) and a crosslinking agent in a ratio of from about 12:1 to about 9:1.

12. The optical article of claim 1, wherein the multilayer optical film comprises a reflective film, a polarizer film, a reflective polarizer film, a diffuse blend reflective polarizer film, a diffuser film, a brightness enhancing film, a turning film, a mirror film, or a combination thereof.

13. The optical article of claim 1, further comprising a microstructured layer disposed on an outer surface of the multilayer optical film opposite the protective layer, wherein the microstructured layer comprises a structured surface having a plurality of microstructures, and the structured surface comprises an outer surface of the optical article.

14. A method of making an optical article, comprising:
providing a multilayer optical film comprising alternating layers of first and second optical layers, wherein the first and second optical layers have refractive indices along at least one axis that differ by at least 0.04;
coating a protective layer composition on the multilayer optical film, the protective layer composition comprising hydroxylated polymer and a crosslinking agent; and
drying the protective layer composition thereby forming a protective layer having a thickness of less than about 0.5 um.

15. The method of claim 14, the protective layer having a thickness of less than about 0.3 um.

16. The method of claim 14, the protective layer having a thickness of less than about 0.1 um.

17. The method of claim 14, wherein the hydroxylated polymer comprises poly(vinyl alcohol) having a degree of hydrolysis of from 88 to 98% and a 4% solution viscosity of from 4 to 56 cP.

18. The method of claim 14, wherein the protective layer composition comprises a crosslinking agent, the crosslinking agent may comprise glutaraldehyde, an epoxy, an isocyanate, a zirconium carboxylate complex, an epichlorohydrin/amine adduct, a melamine/formaldehyde resin, a poly(carbodiimide), or a combination thereof.

19. The method of claim 14, wherein the protective layer composition comprises poly(vinyl alcohol) and a crosslinking agent in a ratio of from about 20:1 to about 5:1.

20. The method of claim 14, wherein the multilayer optical film comprises a reflective film, a polarizer film, a reflective polarizer film, a diffuse blend reflective polarizer film, a diffuser film, a brightness enhancing film, a turning film, a mirror film, or a combination thereof.

21. The method of claim 14, further comprising forming a microstructured layer disposed on an outer surface of the multilayer optical film opposite the protective layer, wherein the microstructured layer comprises a structured surface having a plurality of microstructures, and the structured surface comprises an outer surface of the optical article.

22. A display device comprising:
a display panel;
a light source; and
an optical article disposed between the display panel and the light source, the optical article comprising:
a multilayer optical film comprising alternating layers of first and second optical layers, wherein the first and second optical layers have refractive indices along at least one axis that differ by at least 0.04; and
a protective layer disposed on an outer surface of the multilayer optical film, the protective layer having a thickness of less than about 0.5 um and comprising crosslinked hydroxylated polymer.

23. The display device of claim 22, wherein the optical article further comprises a microstructured layer disposed on an outer surface of the multilayer optical film opposite the protective layer, wherein the microstructured layer comprises a structured surface having a plurality of microstructures, and the structured surface comprises an outer surface of the optical article.

24. A method of making an optical article, comprising:
providing a substrate comprising alternating layers of first and second optical layers;
coating a protective layer composition on the multilayer optical film, the protective layer composition comprising hydroxylated polymer and a crosslinking agent;
drying the protective layer composition thereby forming a protective layer having a thickness of less than about 0.5 um; and
stretching the coated substrate in at least one direction, whereby the first and second optical layers have refractive indices along at least one axis that differ by at least 0.04.

25. The method of claim 24, wherein the optical article comprises a reflective film, a polarizer film, a reflective polarizer film, a diffuse blend reflective polarizer film, a diffuser film, a brightness enhancing film, a turning film, a mirror film, or a combination thereof.
